(19) United States
(12) Patent Application Publication
(10) Pub. No.: US 2012/0052303 A1
(43) Pub. Date: Mar. 1, 2012

(54) ACOUSTIC SHEET AND METHOD OF MANUFACTURING ACOUSTIC SHEET

(75) Inventors: Hiroshi Nakashima, Hamamatsu-shi (JP); Katsunori Suzuki, Tokyo (JP); Toshiharu Fukushima, Hamamatsu-shi (JP); Yukimasa Okumura, Hamamatsu-shi (JP); Kiminori Inoue, Hamamatsu-shi (JP)

(73) Assignee: Yamaha Corporation, Hamamatsu-shi (JP)

(21) Appl. No.: 13/219,452

(22) Filed: Aug. 26, 2011

(30) Foreign Application Priority Data
Aug. 26, 2010 (JP) 2010-189630

(51) Int. Cl. B32B 9/04; B29C 67/00

(52) U.S. Cl. 428/411.1; 156/702

(57) ABSTRACT

In an acoustic sheet which can be used as a head material of a percussion instrument or a head material for a sound box of a string instrument, a plurality of change regions having a crystalline orientation different from a base are dispersed into the base made of a synthetic resin sheet having a uniform crystalline orientation. The acoustic sheet can include a delamination which is formed by delaminating the synthetic resin sheet in a thickness direction.

### INCORPORATION BY REFERENCE

Priority is claimed on Japanese Patent Application No. 2010-189630, filed on Aug. 26, 2010, the content of which is incorporated herein by reference.

### BACKGROUND OF THE INVENTION

1. Field of the Invention

The present invention relates to an acoustic sheet which is used as a material for a musical instrument, a speaker, an indoor acoustic control material, or the like, and a method of manufacturing an acoustic sheet. In particular, the present invention relates to an acoustic sheet which is suitably used as a head material of a percussion instrument, such as a tambourine or a drum, a head material for a sound box of a string instrument, such as a shamisen or a banjo, or the like, and obtains excellent acoustic characteristics close to the acoustic characteristics of a natural material, such as wood or leather, and a method of manufacturing an acoustic sheet.

2. Description of Related Art

Heretofore, as an acoustic sheet which is used as a head material of a percussion instrument, such as a tambourine or a drum, a synthetic material, such as a resin sheet, is known. For example, Japanese Unexamined Patent Application, Publication No. H10-301560 describes a musical instrument head which includes a synthetic resin sheet having a plurality of recessed regions and a resin coating.

A drum head is heretofore known in which a thin-film layer made of metal is laminated on a film formed of a synthetic resin film or the like (for example, see Japanese Unexamined Patent Application, Publication No. S58-194093).

However, there is a problem in that a musical instrument using the synthetic resin sheet in the related art has acoustic characteristics significantly different from the acoustic characteristics of a musical instrument using a natural material, such as wood or leather. Specifically, for example, when the synthetic resin sheet in the related art is used as a head material of a percussion instrument, there is a difference in the acoustic characteristic, such as high-tone sound sticking in ears, compared to a percussion instrument using a natural material.

For this reason, there is a demand for bringing the acoustic characteristics of a musical instrument using an acoustic sheet made of a synthetic material close to the acoustic characteristics of a musical instrument using a natural material.

### SUMMARY OF THE INVENTION

The invention has been finalized in consideration of the above-described situation, and an object of the invention is to provide an acoustic sheet which can be suitably used as a head material of a percussion instrument or a head material for a sound box of a string instrument, and can allow that a musical instrument using the acoustic sheet has excellent acoustic characteristics close to the acoustic characteristics when a natural material, such as wood or leather, is used.

Another object of the invention is to provide a method of manufacturing an acoustic sheet which manufactures the acoustic sheet.

The inventors have been dedicated to give consideration so as to solve the above-described problems. As a result, the inventors have found that, if an acoustic sheet is used in which a plurality of change regions having a crystalline orientation different from a base are formed dispersedly into the base made of a synthetic resin sheet having a uniform crystalline orientation, the acoustic characteristics of a musical instrument using the acoustic sheet are close to the acoustic characteristics when a natural material is used, and the inventors have achieved the invention. The invention uses the following configuration.

An aspect of the invention provides an acoustic sheet in which a plurality of change regions having a crystalline orientation different from a base are formed dispersedly into the base made of a synthetic resin sheet having a uniform crystalline orientation.

The acoustic sheet may include a delamination which is formed by delaminating the synthetic resin sheet in a thickness direction.

Another aspect of the invention provides a method of manufacturing an acoustic sheet. The method includes an impact application step of partially applying an impact to a base made of a synthetic resin sheet having a uniform crystalline orientation to dispersedly form a plurality of change regions having a crystalline orientation different from the base.

In the method, in the impact application step, the synthetic resin sheet may be delaminated in a thickness direction to form a delamination.

In the method, in the impact application step, an impact may be partially applied to the base using a shot blast.

According to the acoustic sheet of the invention, since a plurality of change regions having a crystalline orientation different from the base are formed dispersedly into the base made of a synthetic resin sheet having a uniform crystalline orientation, a musical instrument using the acoustic sheet has excellent acoustic characteristics close to the acoustic characteristics when a natural material, such as wood or leather, is used. Therefore, it is possible to suitably use the acoustic sheet as a head material of a percussion instrument or a head material for a sound box of a string instrument.

The method of manufacturing an acoustic sheet according to another aspect of the invention includes an impact application step of partially applying an impact to a base made of a synthetic resin sheet having a uniform crystalline orientation to dispersedly form a plurality of change regions having a crystalline orientation different from the base. Therefore, it is possible to realize an acoustic sheet which obtains excellent acoustic characteristic close to the acoustic characteristics of a natural material, such as wood or leather.

### BRIEF DESCRIPTION OF THE DRAWINGS

FIG. 1 is a partially sectional perspective view showing an acoustic sheet according to an embodiment of the invention.

FIGS. 2A to 2C are sectional views showing a method of manufacturing an acoustic sheet according to an embodiment of the invention.

FIG. 3A is a sectional view showing an acoustic sheet according to an embodiment of the invention when low-frequency acoustic vibration is applied.

FIG. 3B is a sectional view showing an acoustic sheet according to an embodiment of the invention when high-frequency acoustic vibration is applied.

FIG. 4A is a sectional view showing a synthetic resin sheet having a uniform crystalline orientation only by stretch molding in the related art when low-frequency acoustic vibration is applied.

FIG. 4B is a sectional view showing a synthetic resin sheet having a uniform crystalline orientation only by stretch molding in the related art when high-frequency acoustic vibration is applied.

FIG. 5A is a polarization microscope photograph showing a synthetic resin sheet having a uniform crystalline orientation only by stretch molding in the related art.

FIG. 5B is a polarization microscope photograph showing an acoustic sheet of Example 1 of the invention.

FIGS. 6A and 6B are an appearance photograph and a polarization microscope photograph showing an acoustic sheet of Example 2 of the invention.

FIGS. 7A and 7B are an appearance photograph and a polarization microscope photograph of an acoustic sheet of Example 3 of the invention.

FIGS. 8A and 8B are an appearance photograph and a polarization microscope photograph showing an acoustic sheet of Example 5 of the invention.

FIG. 9 is a microscope photograph showing the cross-section of an acoustic sheet of Example 7 of the invention.

FIG. 10 is a microscope photograph showing the cross-section of an acoustic sheet of Example 8 of the invention.

FIG. 11 is a microscope photograph showing the cross-section of an acoustic sheet of Example 9 of the invention.

FIG. 12A is a graph showing the acoustic characteristics of a percussion instrument which uses an acoustic sheet of an embodiment of the invention as a head material.

FIG. 12B is a graph showing the acoustic characteristics of a percussion instrument which uses a synthetic resin sheet in the related art as a head material.

FIG. 12C is a graph showing the acoustic characteristics of a percussion instrument which uses natural leather as a head material.

### DETAILED DESCRIPTION OF THE PREFERRED EMBODIMENTS

Hereinafter, an embodiment of the invention will be described with reference to the drawings. The drawings which are used in the following description are just illustrations of the configuration of an embodiment of the invention, and the size, thickness, dimensions, or the like of each section may be different from the actual dimensional relationship.

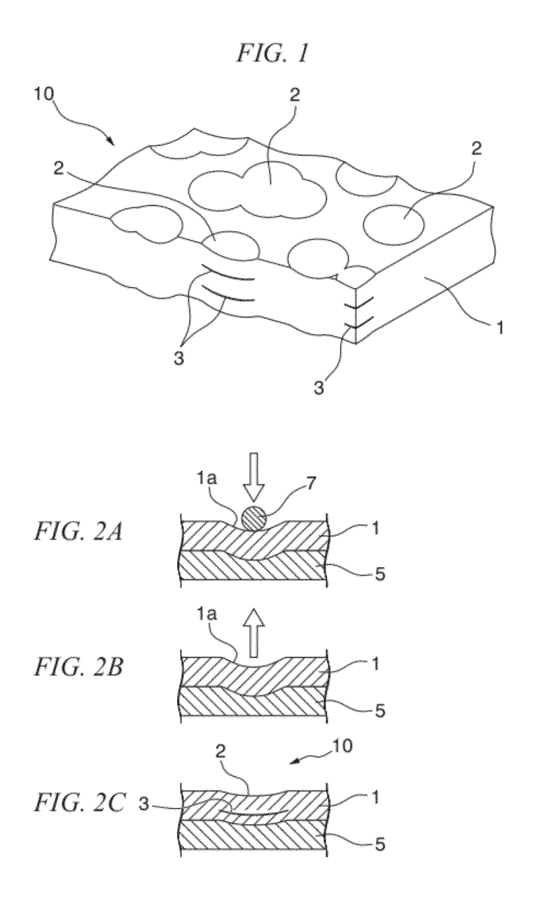

FIG. 1 is a schematic perspective view showing an example of an acoustic sheet which is an embodiment of the invention. As shown in FIG. 1, an acoustic sheet 10 of this embodiment is formed such that change regions 2 and delaminations 3 are formed dispersedly into a base 1.

The base 1 is made of a synthetic resin sheet having a uniform crystalline orientation. Examples of a synthetic resin sheet for the base 1 include synthetic resin sheets made of PET (polyethylene terephthalate), PEN (polyethylene naphthalate), PPE (polyphenylene ether), PBN (polybutylene naphthalate), PBT (polybutylene terephthalate), PSU (polysulfone), PI (thermoplastic polyimide), PC (polycarbonate), PA (polyamide), PMP (polymethylpentene), POM (polyoxymethylene), PEEK (polyether ether ketone), PEI (polyetherimide), and the like. Of the synthetic resin sheets, a synthetic resin sheet made of PET by stretch molding is preferably used as the base 1.

The thickness of the base 1 can be appropriately determined depending on the purpose of the acoustic sheet 10 or the strength of the base 1, and is not particularly limited. In order that the acoustic sheet 10 is used as a head material of a percussion instrument or a head material for a sound box of a string instrument, the thickness of the base 1 is preferably in a range of 100 μm to 500 μm, and more preferably, about 250 μm. From the viewpoint of sufficient strength, the thickness of the base 1 is preferably equal to or greater than 200 μm.

The change regions 2 are regions which have a crystalline orientation different from the base 1. As shown in FIG. 1, the planar shape of each change region 2 may be substantially a circular shape or a shape in which a plurality of eccentric circles overlap each other. However, the planar shape is not particularly limited.

The change regions 2 may be concave portions as shown in FIG. 1, may have a flat surface along the surface of the base 1, or may be convex portions. The depth of each change region 2 in the cross-sectional direction may be a part or the whole of the thickness of the base 1, and is not particularly limited. As shown in FIG. 1, the change regions 2 may be formed only in one surface of the acoustic sheet 10 or may be formed in both surfaces of the acoustic sheet 10.

When the crystalline orientation differs between the base 1 and the change regions 2, this can be confirmed by viewing the crystalline regions in various directions when being observed by a polarization microscope while rotating polarizing plates in a crossed Nicole state where two polarizing prisms (polarizing plates) are arranged on an optical path at 90° in series.

The delaminations 3 are formed by delaminating the synthetic resin sheet constituting the base 1 in the thickness direction. The delaminations 3 are sealed airtight in the base 1, and are, preferably, substantially in a vacuum state. The arrangement of the delaminations 3 or the planar shape and cross-sectional shape of the delaminations 3 in the thickness direction of the acoustic sheet 10 are not particularly limited.

Although in this embodiment, the acoustic sheet 10 in which the change regions 2 and the delaminations 3 are formed has been described as an example of the acoustic sheet of the embodiment of the invention, any acoustic sheet may be used insofar as the change regions 2 are formed. The delaminations 3 may be formed or may not be formed.

Next, a method of manufacturing the acoustic sheet 10 shown in FIG. 1 will be described with reference to FIGS. 2A to 2C.

In manufacturing the acoustic sheet 10 shown in FIG. 1, first, the base 1 made of a synthetic resin sheet having a uniform crystalline orientation is prepared. Next, as shown in FIG. 2A, a backup material 5 is arranged to be in contact with one surface (the lower surface in FIG. 2A) of the base 1. Thereafter, a plurality of impact particles collide against the base 1 to be dispersed evenly over the entire surface of the base 1 from another surface (the upper surface in FIG. 2A) of the base 1 using a shot blast, thereby partially applying an impact to the base 1 (impact application step).

As shown in FIG. 2A, if the impact particles 7 collide against the base 1, the impact particles 7 encroach on the base 1, such that concave portions 1a are formed and a portion where distortion of shear deformation concentrates is formed in the central portion of the base 1 in the thickness direction. Next, as shown in FIG. 2B, when the impact particles 7 are separated from the base 1, the concave portions 1a are partly restored due to the resilience of the base 1, and distortion of shear deformation is released.

As shown in FIG. 2A, in a region where the concave portions 1a are formed due to the collision of the impact particles 7 and a peripheral region, the impact particles 7 collide against the base 1, such that the crystalline orientation changes. Then, as shown in FIG. 2B, even when the concave portions 1a become small due to the resilience of the base 1, the crystalline orientation is different from the crystalline orientation of the base 1. Thus, as shown in FIG. 2C, the region where the concave portions 1a are formed become the change regions 2 which have a crystalline orientation different from the base 1.

In the portion where distortion of shear deformation concentrates in the central portion of the base 1 in the thickness direction when the impact particles 7 collides against the base 1, temporarily concentrated distortion of shear deformation is released. Thus, as shown in FIG. 2C, the synthetic resin sheet is separated in the thickness direction in a portion where distortion of shear deformation most concentrates, and the delaminations 3 are formed.

A method of partially applying an impact to the base 1 is not limited to the above-described method, and for example, an ultrasonic shot blast method or the like may be used. As described above, it is preferable that a plurality of impact particles 7 collide against the base 1 to be dispersed evenly over the entire surface of the base 1 using the shot blast, thereby partially impacting on the base 1.

When a plurality of impact particles 7 collide against the base 1 to be dispersed evenly over the entire surface of the base 1 using the shot blast, the change regions 2 and the delaminations 3 can be easily formed evenly over the base 1. Thus, a high-quality acoustic sheet 10 with no variation is obtained. In this case, the pressure or the number of the colliding impact particles 7, the time when the impact particles 7 collide against the base 1, the distance between the emission portions of the impact particles 7 of the shot blast and the base 1, and the like are adjusted, thereby controlling whether or not to provide the delaminations 3, the shape, the number, and the density of the change regions 2 or the delaminations 3, and the like. Therefore, an acoustic sheet 10 corresponding to desired acoustic characteristics is easily obtained.

Specifically, for example, when a plurality of impact particles 7 collide against the base 1 to be dispersed evenly over the entire surface of the base 1 using the shot blast, the pressure when the impact particles 7 collide against the base 1 is preferably in a range of 0.05 MPa to 0.7 MPa with respect to the base 1 made of PET having a thickness of about 250 μm by biaxial stretch molding. If the pressure exceeds the above-described range, the base 1 may be damaged. If the pressure is less than the above-described range, an insufficient impact is applied to the base 1 when the impact particles 7 collide against the base 1, making it difficult to form the change regions 2 and the delaminations 3.

The distance between the emission portions of the impact particles 7 of the shot blast and the base 1 is preferably 50 mm to 400 mm.

As the impact particles 7 which are used to partially apply an impact to the base 1, particles of metal, ceramic such as zircon which is zirconium-bearing silicate mineral and white alundum made of high-purity alumina, and salt such as sodium bicarbonate, or the like may be used. In order to efficiently apply an impact to the base 1, it is preferable that particles of zircon are used as the impact particles 7.

The shape of the impact particles 7 may be a spherical shape or a polyhedral shape. From the viewpoint of preventing the surface of the base 1 from being damaged, a spherical shape is preferably used.

When the shape of the impact particles 7 is a spherical shape, the particle size of the impact particles 7 is preferably in a range of 50 μm to 2000 μm, and more preferably, in a range of 100 μm to 600 μm.

If the particle size of the impact particles 7 exceeds the above-described range, the curvature of deformation of the base 1 with the collision of the impact particles 7 decreases. For this reason, the crystalline orientation of the base 1 is not easily changed, making it difficult to form the change regions 2. Simultaneously, distortion of shear deformation does not easily concentrate on the central portion of the base 1 in the thickness direction, making it difficult to form the delaminations 3. If the particle size of the impact particles 7 is less than the above-described range, an insufficient impact is applied to the base 1 when the impact particles 7 collide against the base 1, making it difficult to form the change regions 2 and the delaminations 3.

As described above, if the backup material 5 is used when an impact is partially applied to the base 1, the whole of the base 1 is supported by the backup material 5, such that an impact can be stably applied from the impact particles 7 to the base 1 regardless of the position on the base 1. Therefore, it is possible to easily form the change regions 2 and the delaminations 3 evenly in the whole of the base 1. When the backup material 5 is not used, for example, a part of the base 1 may be supported by a support member, and a surface opposite to the surface of the base 1 to which an impact is applied may become a space.

Examples of the material for the backup material 5 include an elastic material, such as foam rubber or silicon rubber, metal, such as aluminum, and the like. The material for the backup material 5 can be appropriately determined depending on the material of the acoustic sheet 10 or necessary acoustic characteristics, and is not particularly limited.

For example, when the formation of the delaminations 3 is suppressed, as the material for the backup material 5, a material having hardness equal to or higher than the base 1, such as metal which is not deformed even when an impact is applied to the base 1, is preferably used. When the formation of the change regions 2 and the delaminations 3 is not obstructed, as the material for the backup material 5, as shown in FIGS. 2A to 2C, a material having hardness equal to or lower than the base 1, such as foam rubber or silicon rubber which is easily deformed to follow the deformation of the base 1 when an impact is applied to the base 1, is preferably used.

In the acoustic sheet 10 of this embodiment, a plurality of change regions 2 having a crystalline orientation different from the base 1 and a plurality of delaminations 3 in the thickness direction of a synthetic resin sheet are formed dispersedly into the base 1 made of a synthetic resin sheet having a uniform crystalline orientation. A musical instrument using the acoustic sheet 10 has excellent acoustic characteristics close to the acoustic characteristics when a natural material, such as wood or leather, is used.

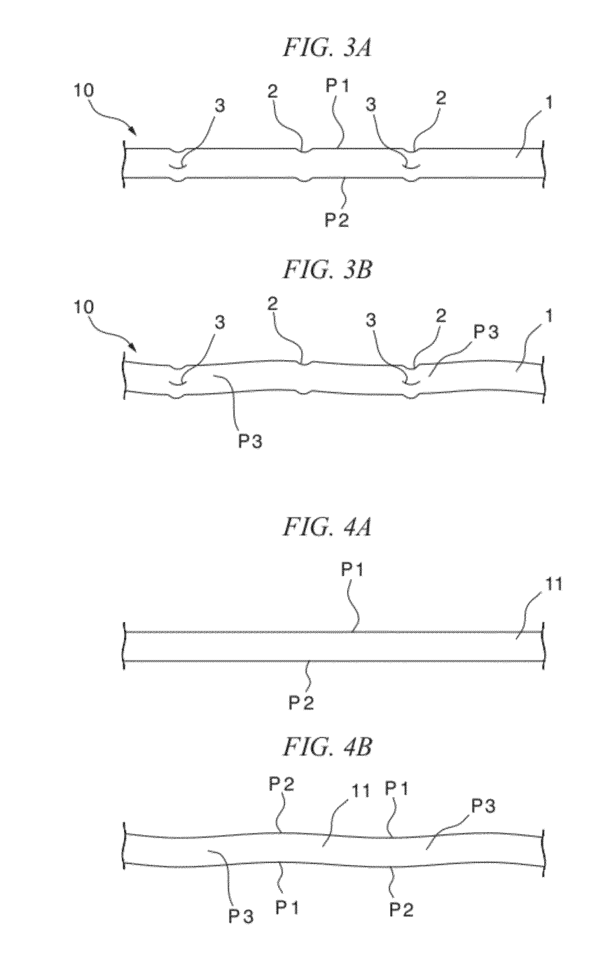

The principle of the invention will be described with reference to FIGS. 3 and 4.

FIG. 3A is a sectional view of the acoustic sheet of this embodiment when low-frequency acoustic vibration is applied. FIG. 3B is a schematic sectional view of the acoustic sheet of this embodiment when high-frequency acoustic vibration is applied. FIG. 4A is a sectional view when low-frequency acoustic vibration is applied to a synthetic resin sheet 11 having a uniform crystalline orientation as a base only by stretch molding. FIG. 4B is a sectional view when high-frequency acoustic vibration is applied to the synthetic resin sheet 11.

As shown in FIGS. 3A and 4A, when low-frequency acoustic vibration (acoustic vibration in a low-frequency band having a long wavelength) is applied, in both the acoustic sheet 10 and the synthetic resin sheet 11, compressive stress P1 is generated inside a flexed curved surface, and tensional stress P2 is generated outside the curved surface, causing bending deformation. At this time, the maximum shear stress P3 is generated on the neutral axis. When the frequency is low, since the curvature of bending deformation is small, shear deformation is intrinsically small, such that a loss of acoustic vibration due to shear deformation is low. Therefore, in both the acoustic sheet 10 and the synthetic resin sheet 11 having a uniform crystalline orientation only be stretch molding, acoustic vibration in a low-frequency band is not easily attenuated.

In contrast, when high-frequency acoustic vibration (acoustic vibration in a high-frequency band having a short wavelength) is applied, in the synthetic resin sheet 11 having a uniform crystalline orientation only by stretch molding, as shown in FIG. 4B, similarly to low-frequency acoustic vibration, compressive stress P1 is generated inside a flexed curved surface, and tensional stress P2 is generated outside the curved surface, causing bending deformation. At this time, the maximum shear stress P3 is generated on the neutral axis. When the frequency is high, since the curvature of bending deformation is large, shear stress increases. However, since the crystal of the base is in a uniform state, misalignment due to shear stress is small and the loss of acoustic vibration is low. Therefore, in the synthetic resin sheet 11, acoustic vibration in the high-frequency band is not easily attenuated.

However, as shown in FIG. 3B, in the acoustic sheet 10 of this embodiment, since a plurality of change regions 2 and delaminations 3 are dispersedly formed, when high-frequency acoustic vibration having high shear stress is applied, misalignment occurs between anisotropic crystals in the change regions 2 and the delaminations 3 due to shear stress, and acoustic vibration is converted to heat, absorbed by the acoustic sheet 10, and attenuated. Therefore, in the acoustic sheet 10 of this embodiment, a loss of acoustic vibration in the high-frequency band is high, and acoustic vibration in the high-frequency band is rapidly attenuated.

According to the experiment of the inventors, similarly to the acoustic sheet 10, it is understood that, when a natural material, such as wood or leather, is used, acoustic vibration in a low-tone range is not easily attenuated, and acoustic vibration in a high-tone range is rapidly attenuated. Thus, according to the acoustic sheet 10 of this embodiment, the acoustic characteristics of a musical instrument using the acoustic sheet 10 are close to the acoustic characteristics when a natural material, such as wood or leather, is used, a low-tone sound is stretched and a high-tone sound is suppressed. Therefore, when the acoustic sheet 10 of this embodiment is used as a head material of a percussion instrument or a head material for a sound box of a string instrument, an excellent musical instrument which produces a harmonious sound is obtained.

Although in the above-described embodiment, the acoustic sheet 10 in which a plurality of change regions are formed in one surface of the base 1 has been described, the invention may include an acoustic sheet in which a plurality of change regions 2 are formed in both surfaces of a base.

### Example 1

An acoustic sheet 10 of Example 1 was manufactured by the following method. First, a base 1 was prepared using a synthetic resin sheet made of biaxially stretched PET (polyethylene terephthalate) (Product Name: LUMIRROR manufactured by Toray Industries, Inc.) to have a thickness of 250 μm and a uniform crystalline orientation. Next, a backup material 5 made of foam rubber (hardness Hs 65°) was arranged to be in contact with one surface of the base 1. Thereafter, a shot blast (manufactured by Fuji Manufacturing Co., Ltd.) was used such that a plurality of impact particles 7 collided against the base 1 to be dispersed over the entire surface of the base 1 from another surface of the base 1, thereby partially applying an impact to the base 1.

As the impact particles 7, zircon particles (Product Name: FZS-425 manufactured by Fuji Manufacturing Co., Ltd.) having a particle size of 425 μm were used. The pressure when the impact particles 7 collided against the base 1 was 0.4 MPa, and the time when the impact particles 7 collided against the base 1 was 10 seconds/100 cm². The distance between the emission portions of the impact particles 7 of the shot blast and the base 1 was 150 mm.

With the above process, the acoustic sheet 10 of Example 1 was obtained.

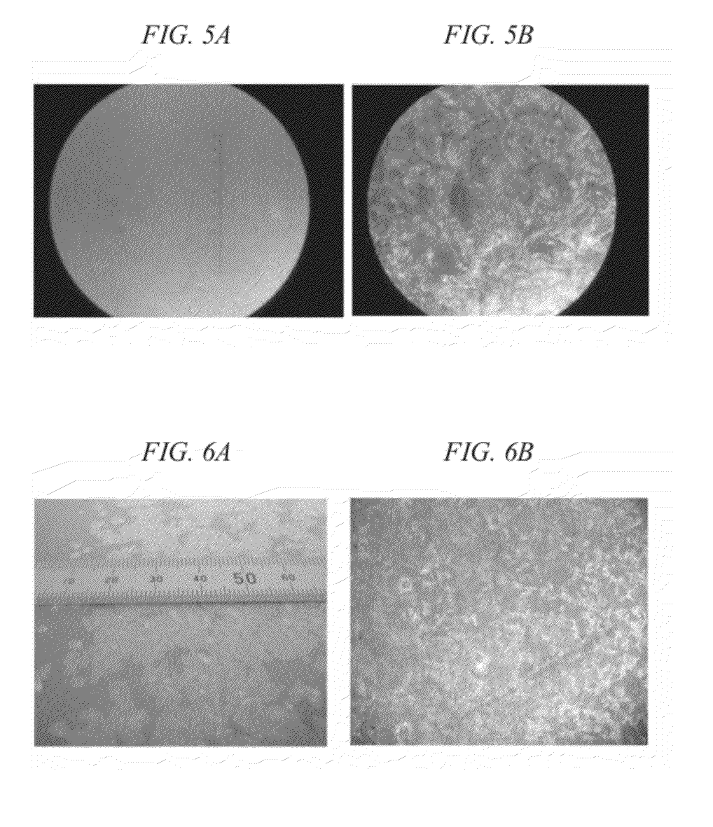

The acoustic sheet 10 of Example 1 obtained in the above-described manner and the base 1 with no change region used when manufacturing the acoustic sheet 10 were photographed using a polarization microscope (manufactured by Nikon Corporation) in a cross Nicole state in which two polarizing prisms (polarizing plates) were arranged on an optical path at 90° in series. The results are shown in FIGS. 5A and 5B.

FIG. 5A is a polarization microscope photograph of a base made of a synthetic resin sheet having a uniform crystalline orientation. FIG. 5B is a polarization microscope photograph of an acoustic sheet according to this example.

As shown in FIGS. 5A and 5B, in the acoustic sheet shown in FIG. 5B, it could be confirmed that a plurality of change regions which are different in the crystalline orientation were formed dispersedly compared to the sheet having a uniform crystalline orientation shown in FIG. 5A. As a result when the cross-section of the acoustic sheet 10 of Example 1 was observed by a polarization microscope, it could be confirmed that a plurality of delaminations were formed dispersedly in the thickness direction of the synthetic resin sheet.

### Example 2

An acoustic sheet 10 of Example 2 was manufactured in the same manner as in Example 1, except that a part of the base 1 was supported by a support member without arranging a backup material 5, such that a surface opposite to the surface of the base 1 to which an impact was applied become a space, and zircon particles (Product Name: FZS-850 manufactured by Fuji Manufacturing Co., Ltd.) having a particle size of 850 μm were used as impact particles 7.

### Example 3

An acoustic sheet 10 of Example 3 was manufactured in the same manner as in Example 1, except that zircon particles (Product Name FZS-600 manufactured Fuji Manufacturing Co., Ltd.) having a particle size of 600 μm were used as impact particles 7.

### Example 4

In the same manner as in Example 3, the impact particles 7 collided against the surface opposite to the surface of the acoustic sheet 10 of Example 3 against which the impact particles 7 have collided, such that an acoustic sheet 10 of Example 4 was manufactured.

### Example 5

An acoustic sheet 10 of Example 5 was manufactured in the same manner as in Example 1, except that the pressure when impact particles 7 collided against the base 1 was 0.2 MPa.

### Example 6

In the same manner as in Example 5, the impact particles 7 collided against the surface opposite to the surface of the acoustic sheet 10 of Example 5 against which the impact particles 7 have collided, such that an acoustic sheet 10 of Example 6 was manufactured.

### Comparative Example 1

The base 1 (a synthetic resin sheet having a uniform crystalline orientation) used in Examples 1 to 6 was used as an acoustic sheet of Comparative Example 1.

Viscoelasticity in a shear direction was measured by the following method as the internal loss (tan σ) of the acoustic sheets of Examples 2 to 6 and Comparative Example 1.

That is, ARES-G2 (Product Name; manufactured by TA Instruments Inc.) was used as a measurement system, the sample length (inter-clamp distance) was 20 mm, the sample width was 10 mm, a displacement of 0.14 rad (≅8.0°) was applied with a tension of 10 g±5 g and a frequency of 1 Hz (2π=6.28 rad/s), and the viscoelasticity in the shear direction was measured.

As a result, the internal loss (tan δ) of the acoustic sheet at normal temperature (25° C.) was 0.0143 in Example 2, 0.0102 in Example 3, 0.0190 in Example 4, 0.0107 in Example 5, 0.0222 in Example 6, and 0.0062 in Comparative Example 1. Thus, it was understood that, in the acoustic sheets of Examples 2 to 6, the internal loss was high and acoustic vibration was easily attenuated, compared to the acoustic sheet of Comparative Example 1.

The acoustic sheets of Examples 2, 3, and 5 were photographed by the following method. FIGS. 6A, 7A, and 8A were photographed using a digital camera (manufactured by Canon Inc.). The minimum value of the scale in FIGS. 6A, 7A, and 8A is 0.5 mm. FIGS. 6B, 7B, 8B were photographed in the same manner as FIGS. 5A and 5B.

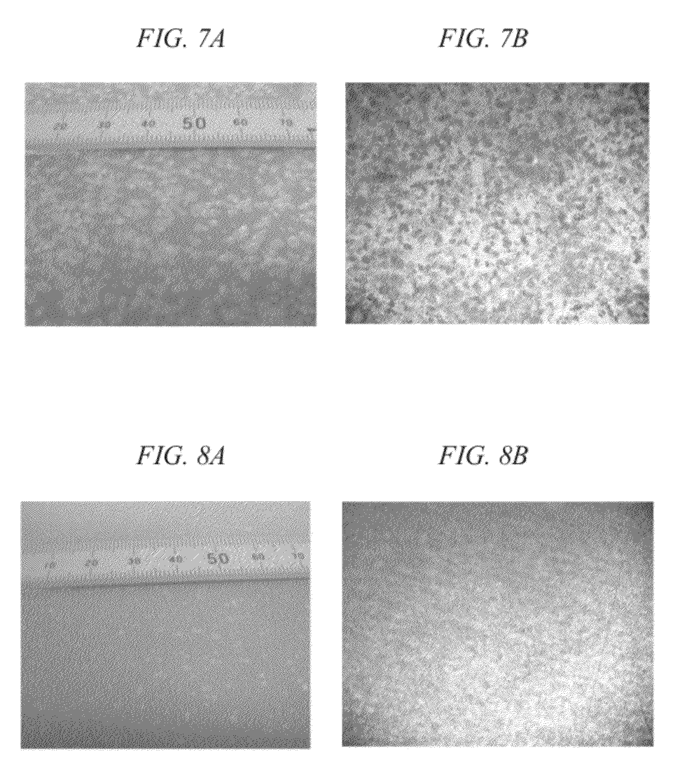

FIGS. 6A and 6B are photographs showing a part of the acoustic sheet of Example 2. FIG. 6A is a photograph of a surface appearance, and FIG. 6B is a photograph of a polarization microscope. FIGS. 7A and 7B are photographs showing a part of the acoustic sheet of Example 3. FIG. 7A is a photograph of a surface appearance, and FIG. 7B is a photograph of a polarization microscope. FIGS. 8A and 8B are photographs showing a part of the acoustic sheet of Example 5. FIG. 8A is a photograph of a surface appearance, and FIG. 8B is a photograph of a polarization microscope.

As shown in FIGS. 6A to 8B, in the acoustic sheets of Examples 2, 3, and 5, it could be confirmed that a plurality of change regions having a crystalline orientation different from the base are formed dispersedly.

As a result, when the acoustic sheets 10 of Examples 2 to 6 were observed in the same manner as in Example 1, it could be confirmed that a plurality of delaminations formed by delaminating the synthetic resin sheet in the thickness direction were formed dispersedly.

### Example 7

An acoustic sheet 10 of Example 7 was obtained in the same manner as in Example 1, except that the pressure when the impact particles 7 collided against the base 1 was 0.2 MPa, and the time was 4 seconds/100 cm².

### Example 8

An acoustic sheet 10 of Example 8 was obtained in the same manner as in Example 1, except that the time when the impact particles 7 collided against the base 1 was 4 seconds/100 cm².

### Example 9

The impact particles 7 collided against one surface of the base 1 in the same manner as in Example 8, except that the time when the impact particles 7 collided against the base 1 was 14 seconds/100 cm², and thereafter, the impact particles 7 collided against a surface opposite to the surface of the base 1 against which the impact particles 7 collided in the same manner as the surface against which the impact particles 7 collided, thereby obtaining an acoustic sheet 10 of Example 9.

The cross-sections of the acoustic sheets 10 of Examples 7 to 9 obtained in the above-described manner were observed by the following method.

That is, the acoustic sheets 10 of Examples 7 to 9 were respectively embedded in thermosetting resin, and the cross-sections thereof bared by polishing were observed.

Specifically, the acoustic sheets 10 of Examples 7 to 9 were cut to a size of about 1 cm angle and arranged such that the surfaces of the acoustic sheets 10 are perpendicular to a cylindrical embedded bottom surface having a diameter of 25 mm and a depth of 20 mm (such that the embedded bottom surface and the cross-sections of the acoustic sheets 10 are in parallel with each other), and epoxy resin was embedded and hardened. Next, the embedded bottom surface was polished by a polishing machine until the cross-sections of the acoustic sheets 10 were bared. The final surface roughness of the polished surface was in the order of 1/100 μm. The cross-sections of the acoustic sheets 10 exposed by polishing were observed by a metallographic microscope at 50 to 600-fold magnification.

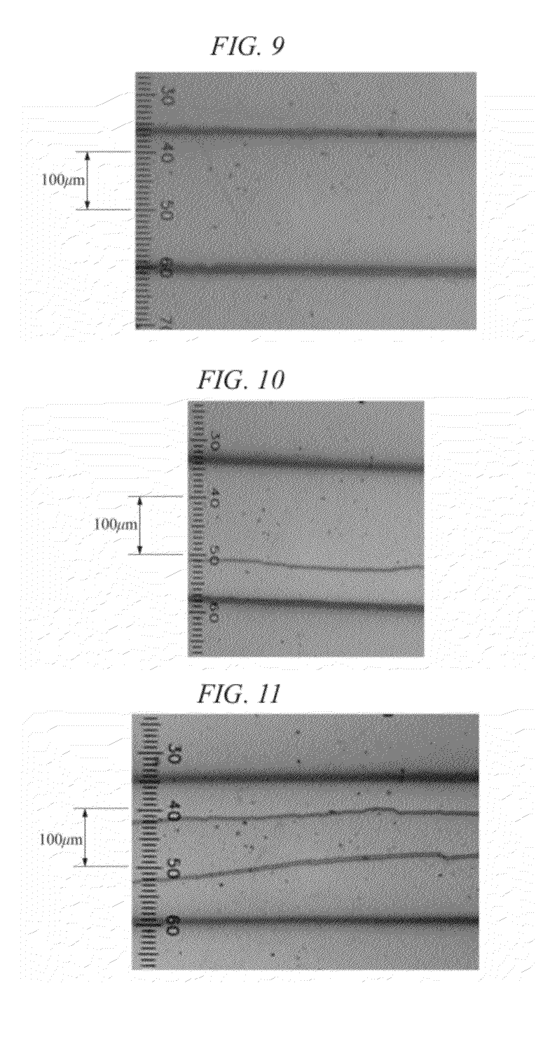

The results are shown in FIGS. 9 to 11. FIG. 9 is a microscope photograph of the cross-section of the acoustic sheet of Example 7. FIG. 10 is a microscope photograph of the cross-section of the acoustic sheet of Example 8. FIG. 11 is a microscope photograph of the cross-section of the acoustic sheet of Example 9.

As a result when the acoustic sheets 10 of Examples 7 to 9 were observed, in all the acoustic sheets 10, a plurality of change regions were formed dispersedly.

As shown in FIG. 9, in the acoustic sheet 10 of Example 7, no delaminations were formed.

As shown in FIG. 10, in the acoustic sheet 10 of Example 8, a plurality of delaminations of a single layer in the thickness direction were formed dispersedly in the surface direction. As shown in FIG. 11, in the acoustic sheet 10 of Example 9, a plurality of delaminations of two layers in the thickness direction were formed dispersedly in the surface direction. It is estimated that this is because the position in the thickness direction differs between the delaminations which are formed when the impact particles 7 collide from one surface and the delaminations which are formed when the impact particles 7 collide from another surface.

### Percussion Instrument

A snare drum having a diameter of 14 inches was manufactured using the acoustic sheet 10 of Example 9 as a head material. A snare drum using the base 1 in the acoustic sheet of Example 8 as a head material, instead of the acoustic sheet of Example 9, and a snare drum using leather as a head material were manufactured in the same manner as the snare drum which uses the acoustic sheet 10 of Example 9 as a head material.

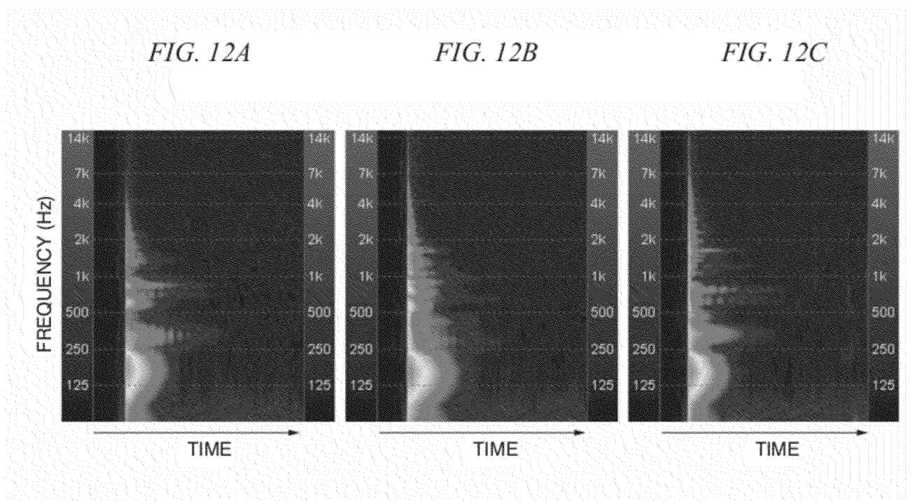

The acoustic characteristics of the snare drums obtained in the above-described manner were examined. The result is shown in FIGS. 12A to 12C.

FIG. 12A is a graph showing the relationship between the frequency of percussion sound of the snare drum using the acoustic sheet of Example 9 as a head material and the time. FIG. 12B is a graph showing the relationship between the frequency of percussion sound of the snare drum of a comparative example using the base 1 made of a synthetic resin sheet having a uniform crystalline orientation prior to manufacturing the acoustic sheet of Example 9 as a head material and the time. FIG. 12C is a graph showing the relationship between the frequency of percussion sound of the snare drum using natural leather as a head material and the time.

It can be understand that the acoustic characteristics of the snare drum using the acoustic sheet of Example 9 shown in FIG. 12A are close to the snare drum using leather shown in FIG. 12C, compared to the snare drum using the base shown in FIG. 12B, a loss of acoustic vibration in the high-tone range (in particular, equal to or higher than 1 kHz) is high, and acoustic vibration in the high-tone range is rapidly attenuated.

When the acoustic sheet 10 is used as a head material (drum head) of a drum, it is preferable that the acoustic sheet has a breaking strain equal to or greater than 0.4 mm/mm in a tensile test. The breaking strain was measured for an acoustic sheet, in which change regions are formed, by the following method.

### Example 10

First, a base 1 was prepared using a synthetic resin sheet made of biaxially stretched PET (polyethylene terephthalate) (Product Name: RUMIRER manufactured by Toray Industries, Inc.) to have a thickness of 250 μm and a uniform crystalline orientation.

The sheet-like base was wound in a roll shape and had a tendency that the strength in the width direction of the sheet was higher than the strength in the winding direction of the roll. The base was cut into rectangular test pieces of 30 mm (inter-clamp distance)×10 mm such that the longer side is in parallel with the width direction of the sheet, and a tensile test was performed. In this case, breaking strain was 1.16 mm/mm. The biaxially stretched sheet material used as a base differs in strength depending on the direction. For this reason, it is preferable that test pieces in multiple directions are cut, a tensile test is performed, and a determination is made in a direction with the minimum breaking strain.

Next, a backup material 5 made of foam rubber (Product Name: PORON (H-48) manufactured by Rogers Inoac Corporation) having hardness of 65° was arranged to be in contact with one surface of the base 1. Thereafter, a plurality of impact particles 7 collided with the base 1 to be dispersed evenly over the entire surface of the base 1 from both surfaces of the base using a shot blast (manufactured by Fuji Manufacturing Co., Ltd.), thereby partially impacting on the base 1.

As the impact particles 7, zircon particles (Product Name: FZS-425 manufactured by Fuji Manufacturing Co., Ltd.) having a particle size of 425 μm were used. The pressure when the impact particles 7 collided against the base 1 was 0.2 MPa, and the time when the impact particles 7 collided against the base 1 was about 2 minutes/A4 per surface. The distance between the emission portions of the impact particles 7 of the shot blast and the base 1 was 150 mm.

With the above process, an acoustic sheet of Example 10 was obtained.

Similarly to the tensile test of the base, the acoustic sheet of Example 10 was cut into rectangular test pieces of 30 mm (inter-clamp distance)×10 mm such that the long side of the base is in parallel with the width direction of the base sheet, and a tensile test was performed. In this case, breaking strain was 0.48 mm/mm. It was understood that the acoustic sheet had sufficient strength as a drum head.

### Comparative Example 2

An acoustic sheet of Comparative Example 2 was manufactured under the same conditions as in Example 10, except that zircon particles (Product Name: FZS-600 manufactured by Fuji Manufacturing Co., Ltd.) having a particle size of 600 μm were used as the impact particles 7, and the pressure when the impact particles 7 collided against the base 1 was 0.4 MPa.

In the same manner as the acoustic sheet of Example 10, the acoustic sheet was cut into test pieces, and a tensile test was performed. As a result, the breaking strain was 0.39 mm/mm. The acoustic sheet is fairly good when used for a drum head, but its strength may sometimes be insufficient when applying excess percussional force.

### Comparative Example 3

An acoustic sheet of Comparative Example 3 was manufactured under the same conditions as in Example 10, except that no backup material was arranged, zircon particles (Product Name: FZS-600 manufactured by Fuji Manufacturing Co., Ltd.) having a particle size of 600 μm were used as the impact particles 7, and the pressure when the impact particles 7 collided against the base 1 was 0.3 MPa.

In the same manner as the acoustic sheet of Example 10, the acoustic sheet was cut into test pieces, and a tensile test was performed. As a result, the breaking strain was 0.23 mm/mm. It was understood that the acoustic sheet has insufficient strength when used as a drum head.

Next, an acoustic effect was measured with respect to the density of the change regions in an acoustic sheet being used as a drum head.

A drum was manufactured experimentally using, as a drum head, an acoustic sheet, in which change regions having delaminations and an impacted concave diameter equal to or greater than 200 μm were formed with a density of one change region per 10 cm² due to the impact of the impact particles 7 or the like on a base made of synthetic resin sheet having a uniform crystalline orientation. Sound produced when this drum and a drum using a base made of a synthetic resin sheet having a uniform crystalline orientation as a drum head were percussed was evaluated aurally. As a result, an acoustic difference between both of them was not perceived.

A drum was manufactured experimentally using, as a drum head, an acoustic sheet, in which change regions having delaminations and an impacted concave diameter equal to or greater than 200 μm were formed with a density of one change region per 5 cm² on the base. Sound produced when this drum and a drum using a base made of a synthetic resin sheet having a uniform crystalline orientation as a drum head were hit was evaluated aurally. As a result, with regard to percussion sound of the former drum, a high-tone range is rapidly attenuated and felt as soft sound.

From above, it was understood that, in an acoustic sheet for a drum head, change regions having delaminations and an impacted concave diameter equal to or greater than 200 μm were formed with a density equal to or more than one change region per 5 cm².

Although the embodiments of the invention have been described in detail with reference to the drawings, a specific configuration is not limited to the embodiments, and may include design or the like (additions, omissions, substitutions, and alteration) without departing from the gist of the invention. The invention is defined only by the appended claims, and not by the above description.

What is claimed is:

1. An acoustic sheet,
wherein a plurality of change regions having a crystalline orientation different from a base are dispersed into the base made of a synthetic resin sheet having a uniform crystalline orientation.

2. The acoustic sheet according to claim 1,
wherein the acoustic sheet includes a delamination which is formed by delaminating the synthetic resin sheet in a thickness direction.

3. The acoustic sheet according to claim 1,
wherein breaking strain in a tensile test is equal to or greater than 0.4 mm/mm.

4. The acoustic sheet according to claim 2,
wherein one or more change regions having the delamination and an impacted concave diameter equal to or greater than 200 μm are formed per 5 cm².

5. A method of manufacturing an acoustic sheet, the method comprising:
a step of preparing a base made of a synthetic resin sheet having a uniform crystalline orientation; and
an impact application step of partially applying an impact to the base to disperse and form a plurality of change regions having a crystalline orientation different from the base.

6. The method according to claim 5,
wherein, in the impact application step, the synthetic resin sheet is delaminated in a thickness direction to form a delamination.

7. The method according to claim 5,
wherein, in the impact application step, an impact is partially applied to the base using a shot blast.

8. The method according to claim 7,
wherein a pressure when an impact particle which is used in the shot blast collides against the base is 0.05 MPa to 0.7 MPa.

9. The method according to claim 7,
wherein an impact particle which is used in the short blast is emitted at a distance of 50 mm to 400 mm from the base.

10. The method according to claim 7,
wherein an impact particle which is used in the shot blast is one selected from a group consisting of metal, ceramic, and salt.

11. The method according to claim 7,
wherein the particle size of an impact particle which is used in the shot blast is 50 μm to 2000 μm.

12. The method according to claim 5, further comprising:
a step of supporting the base by a backup material on a surface opposite to a surface of the base to which the impact is applied.

13. The method according to claim 12,
wherein the backup material is one selected from a group consisting of foam rubber, silicon rubber, and aluminum.

14. The method according to claim 12,
wherein, the synthetic resin sheet is delaminated in a thickness direction to form a delamination in the impact application step by using the backup material having hardness equal to or greater than the hardness of the base.
